(19) United States
(12) Patent Application Publication
(10) Pub. No.: US 2012/0227583 A1
(43) Pub. Date: Sep. 13, 2012

(54) METHOD FOR PURIFYING A GAS FLOW IMPLEMENTING A CONTACTOR HAVING PARALLEL PASSAGES WHILE MAINTAINING THE PERFORMANCE THEREOF

(75) Inventors: Christian Monereau, Montpellier (FR); Francois Fuentes, Le Vesinet (FR); Celine Carriere, Levallois-Perret (FR); Bhadra S. Grover, Sugar Land, TX (US); Yudong Chen, Garnet Valley, PA (US); Madhava Kosuri, Newark, DE (US)

(73) Assignee: L'Air Liquide Societe Anonyme Pour L'Etude Et L'Exploitation Des Procedes Georges Claude, Paris (FR)

(21) Appl. No.: 13/510,404

(22) PCT Filed: Nov. 4, 2010
(86) PCT No.: PCT/EP2010/066770

§ 371 Date: May 17, 2012

(30) Foreign Application Priority Data
Nov. 19, 2009 (FR) 0958170

(51) Int. Cl. B01D 53/047

(52) U.S. Cl. 95/96

(57) ABSTRACT

The invention relates to a method for purifying a gas flow including at least a first compound selected from the compounds of a first group including water, ammonia, aromatics, alkane-, alkene-, or alkyne-type hydrocarbons containing at least 5 carbon atoms, aldehydes, ketones, halogen hydrocarbons, hydrogen sulfide, hydrogen chloride, and at least second and third compounds selected from the compounds of a second group including helium, hydrogen, nitrogen, oxygen, argon, carbon monoxide, carbon dioxide, hydrocarbons lower than C5, wherein said method comprises a variable-pressure adsorption implementing at least one main adsorber comprising at least one contactor having parallel passages, characterized in that said first compound is at least partially stopped upstream from said main adsorber.

The invention relates to a process for the purification of a gas stream comprising at least one first compound chosen from the compounds of the first group, formed by water, ammonia, aromatic compounds, hydrocarbons of C₅+ alkane, alkene or alkyne type, that is to say comprising at least 5 carbon atoms, aldehydes, ketones, halogenated hydrocarbons, hydrogen sulfide and hydrogen chloride, and at least one second compound and one third compound chosen from the compounds of the second group, formed by helium, halogen, nitrogen, oxygen, argon, carbon monoxide, carbon dioxide and C₁-C₅ hydrocarbons, by pressure swing adsorption (PSA), employing at least one main adsorber comprising at least one parallel-passage contactor.

Adsorption is a physical phenomenon increasingly used industrially to separate or purify gas streams.

For example, adsorption is conventionally used to dry various gas streams, in particular air or natural gas, for the production of hydrogen, for the production of oxygen and/or nitrogen from atmospheric air, for capturing numerous constituents of various effluent streams before they are used in a downstream process or they are vented such as VOCs, nitrogen oxides, mercury, and the like.

The processes employed are either lost-charge processes (reference is then generally made to guard bed) or regenerable processes. Regeneration is carried out either by lowering the pressure or by increasing the temperature. It is also possible to couple together these two effects. Reference is made respectively to PSA (pressure swing adsorption), TSA (temperature swing adsorption) or PTSA (pressure temperature swing adsorption).

When the regeneration of PSA is carried out under vacuum, the abbreviation VSA (vacuum swing adsorption) is generally used.

Subsequently, and except in particular applications, only the terms PSA and TSA will be used, for the sake of simplicity, to describe all these adsorption processes comprising an in situ regeneration stage, depending upon whether the predominant effect used to regenerate the adsorbent is the pressure or the temperature.

The adsorbent used is generally provided in the form of particles with which an adsorber is filled. These particles can be in the form of granules, rods, beads or crushed materials. The characteristic dimensions of these particles generally range from 0.5 mm to 5 mm. The smallest particles make it possible to improve the adsorption kinetics and consequently the efficiency of the process but, on the other hand, they create large pressure drops in the fluid phase.

In order to counterbalance this effect, use is made of adsorbers exhibiting a large passage cross section to the fluid, such as cylindrical adsorbers having a horizontal axis or radial adsorbers.

However, when it is desired to proceed further in improving the pressure drop and/or the kinetics, this technology results in adsorber geometries not applicable on the industrial scale.

This is the case, for example, when it is desired to treat high gas flow rates at low pressure, such as for the capture of CO₂ in effluent streams at atmospheric pressure, or when it is desired to carry out rapid cycles, in particular PSA cycles.

In 1996, Ruthven et Thaeron, in Gas Sep. Purif., vol. 10, p. 63, showed that such an improvement can be obtained using parallel-passage contactors.

This is a system in which the fluid passes through channels, the walls of which comprise adsorbent.

The use of this type of contactor makes it possible to accelerate the cycles and thus to increase the productive output.

One disadvantage of this saving is an increased risk of contamination for the adsorbent. The document FR 2 800 297 deals with this aspect with reference to the entries of moisture which concern increasingly small amounts of sieve as the cycles improve. The article “PSA technology hits the fast lane; Fast-cycle technology promises to reduce the size and costs of PSA gas-separation equipment” by Matt Babicki and taken from the internet site chemicalprocessing.com deals with H₂ PSAs comprising contactors and having a fast cycle. The chapter “Not Perfect” of this article also explains that the small amount of adsorbent involved renders the PSA more vulnerable to contamination by liquids (water, hydrocarbons) and recommends a careful design of the liquid/gas separator upstream of the PSA in order to prevent any entrainment and consequently any contamination. Improved materials used in the contactors, materials which are not disclosed, may also prevent this contamination.

The suppression of the entries of moisture of course helps in maintaining the effectiveness over time provided that water-sensitive adsorbents are used. The solutions are conventional and range from strengthening the watertightness, the use of dry barrier gas, controlled external escapes in order to prevent any entry of water into the system. In the event of shutdown of the unit, a slight pressurization of the unit is also provided, with an optional minimum leakage, with the same aim and optionally to prevent the migration of impurities from the inlet towards the outlet of the contactor.

It turns out that these precautions are generally insufficient and that, despite their use, the effectiveness of the system rapidly falls in a certain number of cases.

In a conventional unit, that is to say a unit not comprising a parallel-passage contactor and exhibiting a stage time generally of greater than 30 seconds, it is standard practice to restrict the duration of a stage by a minimum value and a maximum value and to calculate the duration of the stage underway as a function of the operating conditions, in particular the flow rate. In the event of a problem, numerous regulatory and/or safety devices can intervene in order to correct the fault or to render the unit safe. The response times are of the order of a second, that is to say a few percent of the stage time. This can be reflected in the fact that, for example, 3% more gas than provided for in the design is entered, that is to say also 3% more impurities.

Conversely, in the case of PSA units having parallel-passage contactors, when reference is made to a few seconds, indeed even fractions of a second, the slightest disturbance to the cycle will result in the introduction of several tens of percent more indeed impurities, even several times the normal amount.

Starting from such a situation, which is difficult to avoid with standard industrial control devices, completely different developments in the performance levels of the units may be found. After temporary contamination of the production for a few cycles, some units will regain their original performance levels while others will not recover these initial performance levels. It is apparent that the sequence of the adsorbents with respect to the impurities plays an essential role in explaining this effect. Specifically, the optimization of the PSA cycles results in the following system: to an impurity corresponds at least one adsorbent. During an incident of the type described above, in a conventional PSA, the impurity will not leave its adsorption region or, at the worst, will overflow onto the following region. In the case of a PSA comprising a parallel-passage contactor, the impurity will be adsorbed at the minimum in the following layer and very probably in several of the following layers.

Starting from this, a problem which is posed is that of providing a process for the purification of a gas stream employing a PSA comprising at least one parallel-passage contactor, the integrity of the initial performance of which is retained.

To this end, a subject matter of the invention is a process for the purification of a gas stream comprising at least one first compound, chosen from the compounds of the first group formed by water, ammonia, aromatic compounds, hydrocarbons of alkane, alkene or alkyne type comprising at least 5 carbon atoms, aldehydes, ketones, halogenated hydrocarbons, hydrogen sulfide and hydrogen chloride, and at least one second compound and one third compound, chosen from the compounds of the second group formed by helium, hydrogen, nitrogen, oxygen, argon, carbon monoxide, carbon dioxide and C₁-C₅ hydrocarbons, by pressure swing adsorption (PSA), employing at least one main adsorber (17-2) comprising at least one parallel-passage contactor, characterized in that:
the first compound is at least partially halted by a TSA unit (17-1) placed upstream of the said main adsorber (17-2), and
the main adsorber follows a pressure cycle comprising an adsorption phase with a duration of less than 15 seconds and a regeneration phase in which the residual gas is withdrawn from the main adsorber.

Preferably, at least a portion of the residual gas is compressed for the purpose of a subsequent use.

It should be noted that, if the residual gas is enriched in CO₂, its compression requires that it be dry in order to prevent problems of corrosion. The TSA placed upstream makes it possible to solve this problem.

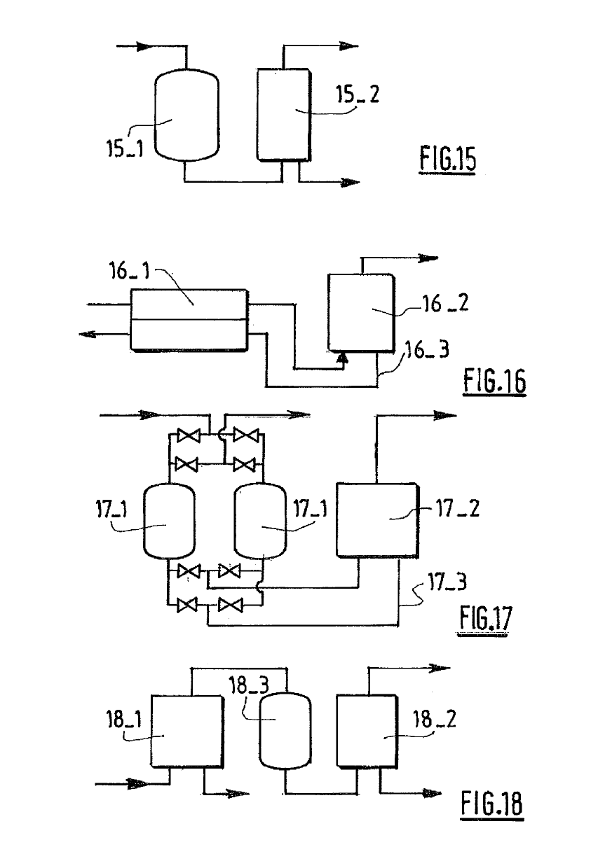

A device which makes possible the implementation of the purification process according to the invention is represented diagrammatically in FIG. 15. In FIGS. 16 to 18, the main adsorber is also represented with the references 16-2, 17-2 and 18-2.

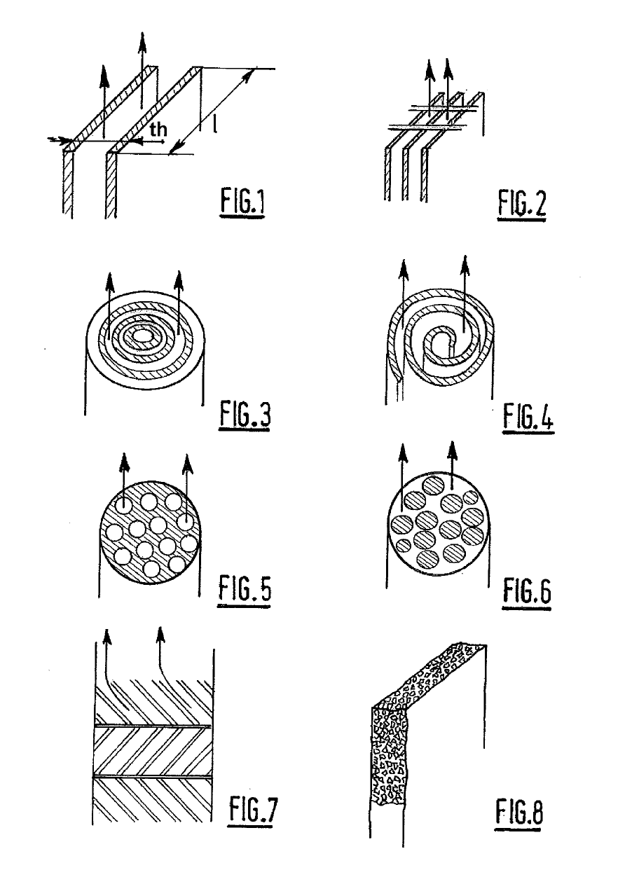

FIGS. 1 to 7 diagrammatically represent, nonexhaustively, the various types of parallel-passage contactors. This is because the contactors can comprise channels of various forms and various dimensions. The following are then distinguished:
rectangular channels having a thickness th which is low with respect to their width w, that is to say with w greater than 10 th (FIG. 1);
essentially square or rectangular channels but with th of the same order of magnitude as the width w (FIG. 2);
channels of intermediate shape, with the large dimension in a ratio of 1.5 to 10 with respect to the small dimension (ellipse, rectangle, and the like);
channels arranged in circular rings (FIG. 3);
channels arranged in the form of a helix (FIG. 4);
circular channels (FIG. 5).

The fluid can also move through the free space left by solid walls presented in the form of cylinders or fibers (FIG. 6). The solid walls can also have the “packing” configuration, as used in distillation (FIG. 7). In the latter case, it is possible to use all the geometrical possibilities relating to said packings by varying the bending angles, the orientation of the passages with respect to the vertical (contactor assumed to be vertical), the dimensions of the channels, and the like.

Numerous configurations are possible as the geometry of the channels is variable (triangle, trapezium, ellipse, and the like). Generally, in all these types of contactors capable of being used in the context of the invention, the fluid, which is preferably a gas stream, moves through channels exhibiting little (or no) obstacle to the flow and the adsorbent is situated on—or constitutes—the wall of said channels.

By way of example, the documents EP 1 413 348, EP 1 121 981 and WO 2005/094987 describe parallel-passage contactors.

Generally, parallel-passage contactors are preferred to the conventional solution of particle beds as soon as the effects of a decrease in the pressure drop become predominant and make it possible to compensate for the probable additional cost related to the adoption of the new type of adsorber.

The contactor itself, and more particularly the support/wall assembly, is produced according to various techniques which can, for example, be classified according to the way in which the adsorbent is incorporated in the wall.

In the “monolith” case, the adsorbent, optionally mixed with a binder, directly constitutes the wall of the channels (FIG. 8).

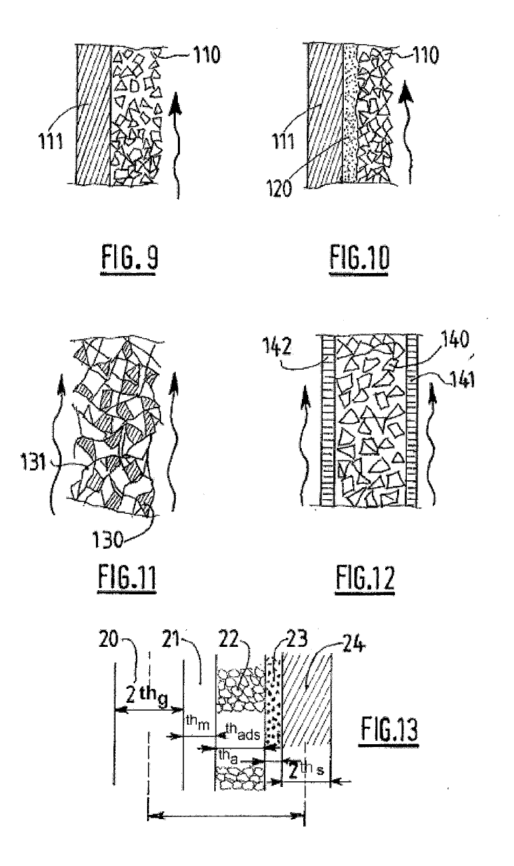

In the more general case of “supported” adsorbent, the adsorbent (110) is fixed to a support (111), for example a metal sheet. Adhesion to the wall may be brought about via the binder of the adsorbent (the role of which is then twofold: agglomeration of the microparticles of adsorbents to one another and fixing to the wall), as illustrated in FIG. 9, or via a specific adhesive (120) (FIG. 10). The support will generally have been treated in order to facilitate adhesion; it can be porous in nature (membrane, fabric, and the like). Numerous materials can be used, such as polymers, ceramics, metals, paper, and the like.

The support for the adsorbent can be folded (before or after deposition of the adsorbent layer) and this folded sheet can itself be wound around a central axis. FIG. 3 of the document U.S. Pat. No. 5,771,707 shows such an arrangement. In the case of folds of essentially triangular shape, the height of the triangle and its base will generally be between 0.5 and 5 mm.

The adsorbent can also be confined. Two subgroups are also found for this technique: the “confining” can be homogeneous, that is to say that the particles of adsorbents (130) are immobilized by a network of fine and dense fibers (131) which occupy the entire volume of the wall (FIG. 11). An adhesive may be added to reinforce the fixing. The confining of adsorbent particles in networks of fibers has been used in the manufacture of gas masks. However, it should be noted that, in the latter case, the air breathed in passed through the adsorbent medium, whereas, in the case envisaged here, the gas stream runs along the wall comprising the adsorbent.

According to another embodiment, the particles of adsorbents (140) are held between two walls (141, 142) which are porous to the fluid (FIG. 12). In this case also, a binder and/or an adhesive can be added in order to improve, if necessary, the maintenance of the particles between the porous walls.

These walls can be of metal or polymer type, and the like. They are chosen so as to be able simultaneously to comprise the particles of adsorbents and not to create significant resistance to the diffusion of the molecules.

By way of example, the documents U.S. Pat. No. 7,300,905 and U.S. Pat. No. 5,120,694 give a nonexhaustive description of these technologies.

FIG. 13 represents the base cell, that is to say the smallest element which makes it possible to describe the geometry of a parallel-passage contactor.

From left to right, there is found the channel (20), through which the gas stream moves, with a total thickness of 2 th_{g}, the porous membrane which maintains the absorbent (21), with a thickness of thₘ, the layer of adsorbent (22), with a thickness of th_{ads}, an adhesive layer (26), with a thickness of thₐ, and the support sheet (24), with a total thickness of 2 thₛ. The base cell thus has the dimension th_{g}+thₘ+th_{ads}+thₐ+thₛ. The orders of magnitude of these thicknesses are, for example:
from 50 microns to 3 mm for the channel, let us say 2 th_{g}=150 microns
from 10 to 100 microns for the porous membrane, if it exists, let us say 25 microns
from 20 microns to 3 mm for the layer of adsorbents, let us say 50 microns
from 5 to 500 microns for the adhesive layer, if it exists, let us say 10 microns
from 5 microns to 1 mm for the support sheet, if it exists, let us to say 2 thₛ=100 microns.

The base cell would thus have, in the example, a thickness of 210 microns (75+25+50+10+50).

Each of these layers is characterized by a series of physical properties:
the support sheet by its density, its heat capacity, its thermal conductivity and possibly its porosity;
likewise the adhesive layer by its density, its heat capacity, its thermal conductivity and possibly its porosity;
the layer of adsorbent by its total porosity, by the mean size of the macropores, by the density of the particles of adsorbents, possibly their size and their internal porosity, its heat capacity, its thermal conductivity and by the adsorption and coadsorption isotherms linking the adsorbent and the molecules present in the gas stream;
the membrane by its total porosity, the main diameter of the pores, the heat capacity, the density, the thermal conductivity and the roughness on the fluid wall side.

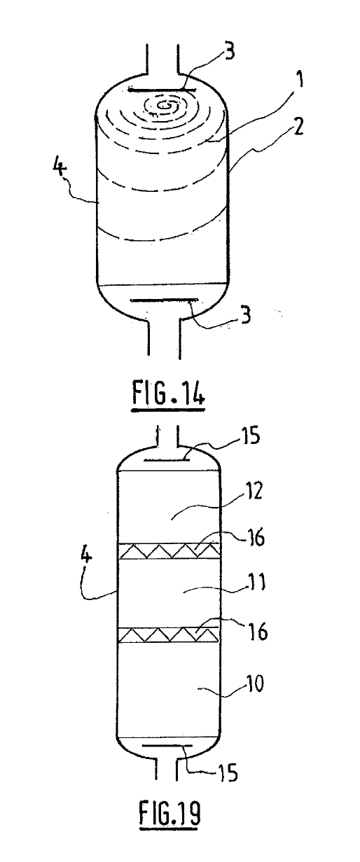

FIG. 14 represents an example of an adsorber comprising a parallel-passage contactor. The cylindrical contactor (1) is housed in a metal casing (2) comprising a bottom end and a top end with openings for the passage of the gas stream. The contactor rests on the bottom end of the casing (4). Diffusers (3) in the upper and lower parts the satisfactory distribution of the incoming and outgoing gas streams. Airtightness at the internal wall of the casing (4), in order to prevent preferential passage of the gas stream at this point, is achieved by the simple pressure of the contactor rolled beforehand over the wall of the casing. If necessary, this airtightness can be improved by any one of the known means (gaskets, welding, adhesive bonding, and the like).

To summarize, parallel-passage contactor is understood to mean a device in which the fluid passes through channels, the walls of which comprise adsorbent. The fluid moves through channels which are essentially devoid of obstacles, these channels allowing the fluid to move from an inlet to an outlet of the contactor. These channels can be rectilinear, directly connecting the inlet to the outlet of the contactor, or can exhibit changes in direction. During its movement, the fluid is in contact with at least one adsorbent present on said walls.

As the case may be, the adsorber according to the invention can comprise one or more of the following characteristics:
a stream enriched in second compound and depleted in third compound is recovered at the outlet of the main adsorber;
the main adsorber follows a pressure cycle, the adsorption time of which is less than 30 seconds, preferably between 2 and 15 seconds; reference will be made in this case to fast PSA;
the main adsorber follows a pressure cycle comprising an adsorption phase with a duration of less than 5 seconds and a regeneration phase in which the residual gas is withdrawn from the main adsorber, and a variable portion of said residual gas is recycled on the feed side of the main adsorber. Reference will be made in this case to superfast PSA. This is because, by virtue of the recycling, the duration of the adsorption phase can be substantially shorter than the duration necessary in order to obtain the maximum effectiveness which can be achieved by this type of unit. The adsorption time is generally between 0.1 and 5 seconds;
the first compound is at least partially halted by an adsorption unit (17-1) or a permeation membrane (16-1) placed upstream of said main adsorber (FIGS. 16 and 17);
the adsorption unit (17-1) is chosen from a renewable charge guard bed, a TSA unit, a PSA unit exhibiting an adsorption time of greater than 15 seconds, or a PSA unit (18-1) comprising a parallel-passage contactor, in combination with a guard bed (18-3) (FIGS. 17 and 18);
the adsorption unit is regenerated or the permeation membrane is eluted with a stream (17-3 or 16-3) resulting from the main adsorber or with a stream external to the main adsorber;
the main adsorber comprises at least two parallel-passage contactors arranged in series. The use of parallel-passage contactors arranged in series makes it possible to treat large amounts of fluid, in particular gas streams of several hundred or several thousand Nm³/h, and/or to obtain products of very high purity (99.9%, for example);
the second compound is hydrogen or CO₂;
the second compound is hydrogen, the third compound is chosen from carbon dioxide, methane, carbon monoxide and nitrogen, and a stream enriched in hydrogen and depleted in third compound is recovered at the outlet of the main adsorber.

The adsorbents capable of being used in the parallel-passage contactors are those used in conventional units for the separation or purification of gas streams. The choice depends on the application. It is possible, in one and the same contactor, to successively use several different adsorbents. Mention may be made of silica gels, activated alumina which is optionally doped, active charcoals, zeolites of various types (3A, 4A, 5A, type X, LSX, Y, and the like, optionally exchanged, and the like) or metal-organic framework adsorbents (MOF, and the like). The zeolites are generally used in the form of microcrystals, indeed even of nanocrystals, according to the processes of synthesis. Other adsorbents, for example active charcoals, can be crushed in order to obtain particles with a size of the order of a micron.

Nevertheless, an additional means for limiting the problem of decline in the initial performance of the mean adsorber is to choose adsorbers not exhibiting an excessively high affinity for the constituents present. Specifically, if the adsorbents of the layers above that where said impurity normally has to be halted exhibit an excessively high affinity for this impurity, the PSA may not be regenerated by a simple pressure effect.

It is possible, for example, to use silica gel, activated alumina and/or charcoal in a CO₂ PSA in place of the molecular sieve 13X. At the most, a few percent may be lost in the performance but the sieve-free solution will be much more robust. Use may be made of H₂ PSAs with active charcoal or silica gel/active charcoal as adsorbent in place of highly specialized multilayers.

FIG. 19 illustrates in particular the arrangement of three contactors in series in an adsorber. The three contactors (10), (11) and (12) are superimposed in the same casing (4) comprising a bottom end and a top end equipped with inlet/outlet openings for the gas streams. Deflectors or diffusers (15) make possible, in the lower and upper part, good distribution of the gas streams. Intermediate distributors (16) make it possible to recover the streams exiting from one contactor and to redistribute them homogeneously in the following contactor. These distributors (16) can be specific items of equipment forming a transition between two contactors and operating so as not to block the channels allotted to the fluids. It can in particular be a grating, metal mesh, spider and more generally spacer not impeding the flow of the fluid. Furthermore, the ends of at least one contactor can be adapted in order to facilitate the flow of the fluid between the contactors. This adaptation can consist in widening, for example the final centimeter of the support, in order to create a large passage region for the fluid, which can thus be more easily redistributed in the second contactor. Another solution can consist in isolating each of the contactors with the wall of the external casing, for example leaving a gap (free space) between contactors.

The three contactors can be identical or, on the contrary, it is possible to use this invention to mark out at least one contactor and to adapt it to the operating conditions occurring at this level of the adsorber. As regards this modification, it can concern another type of adsorbent, a modification to the thickness of the adsorbent layer, to the passage cross section, and the like.

1-7. (canceled)

8. A process for the purification of a gas stream comprising at least one first compound, selected from the compounds of a first group formed by water, ammonia, aromatic compounds, hydrocarbons of alkane, alkene or alkyne type comprising at least 5 carbon atoms, aldehydes, ketones, halogenated hydrocarbons, hydrogen sulfide and hydrogen chloride, and at least one second compound and one third compound, chosen from the compounds of a second group formed by helium, hydrogen, nitrogen, oxygen, argon, carbon monoxide, carbon dioxide and C₁-C₅ hydrocarbons, by pressure swing adsorption, employing at least one main adsorber comprising at least one parallel-passage contactor, wherein:
the first compound is at least partially halted by a temperature swing adsorption unit placed upstream of the main adsorber, and
the main adsorber follows a pressure cycle comprising an adsorption phase with a duration of less than 15 seconds and a regeneration phase in which a residual gas is withdrawn from the main adsorber.

9. The process of claim 8 wherein a stream enriched in the second compound and depleted in the third compound is recovered at an outlet of the main adsorber.

10. The process of claim 8 wherein the main adsorber follows a pressure cycle, the adsorption time of which is between 2 and 15 seconds.

11. The process of claim 8 wherein the main adsorber follows a pressure cycle comprising an adsorption phase with a duration of less than 5 seconds and a regeneration phase in which the residual gas is withdrawn from the main adsorber, and a variable portion of said residual gas is recycled on the feed side of the main adsorber.

12. The process of claim 8 wherein the main adsorber comprises at least two parallel-passage contactors arranged in series.

13. The process of claim 8 wherein the second compound is hydrogen or CO₂.

14. The process of claim 8 wherein the second compound is hydrogen, the third compound is chosen from carbon dioxide, methane, carbon monoxide and nitrogen, and a stream enriched in hydrogen and depleted in third compound is recovered at the outlet of the main adsorber.
